(19) United States
(12) Patent Application Publication
(10) Pub. No.: US 2012/0003508 A1
(43) Pub. Date: Jan. 5, 2012

(54) BATTERY OF ELECTROCHEMICAL GENERATORS COMPRISING A FOAM AS INTER-GENERATOR FILLER MATERIAL

(75) Inventors: Alexandre NARBONNE, Bordeaux (FR); Benoît TURBE, Bordeaux (FR); Olivier RABAUD, Bordeaux (FR)

(73) Assignee: SAFT, Bagnolet (FR)

(21) Appl. No.: 13/167,521

(22) Filed: Jun. 23, 2011

(30) Foreign Application Priority Data
Jul. 2, 2010 (FR) 10 55 366

(51) Int. Cl. H01M 2/10; H01M 14/00

(52) U.S. Cl. 429/8

(57) ABSTRACT

A battery of lithium electrochemical generators including a casing; a plurality of lithium electrochemical generators housed in the casing, each generator including a container; a rigid, flame-retardant foam with closed porosity formed of an electrically insulating material filling the space between the inner wall of the casing and the free surface of the side wall of the container of each electrochemical generator, the foam covering the free surface of the side wall of the container of each electrochemical generator over a length representing at least 25% of the height of the container.

### TECHNICAL FIELD

The technical field to which the invention relates concerns batteries of electrochemical generators of lithium-ion type. The invention also concerns the protection of lithium electrochemical generators against thermal runaway.

### STATE OF THE ART

An electrochemical generator is a device for producing electricity in which chemical energy is converted to electric energy. Chemical energy is formed of electrochemically active compounds deposited on at least one face of electrodes arranged in the electrochemical generator. Electric energy is produced by electrochemical reactions during discharge of the electrochemical generator. The electrodes, arranged in a container, are electrically connected to current output terminals which ensure electric continuity between the electrodes and an electric consumer with which the electrochemical generator is associated. The positive and negative current output terminals can be secured either on the walls of opposite sides of the container of the electrochemical generator, or on the wall of one same side of the container.

Several electrochemical generators can be connected together in series or in parallel in relation to the nominal operating voltage of the electric consumer and to the quantity of energy intended to be supplied to this consumer. The electrochemical generators are then placed in a common casing, and the assembly of the casing and of the plurality of electrochemical generators that it contains is generally called a battery. For practicality of the electrical connection between the electrochemical generators placed in a battery, the positive and negative current output terminals are often fixed to the wall of one same side of the container.

An operating anomaly of the battery may be caused by the dysfunctioning of one of the electrochemical generators (short-circuit, overload . . . ) or by an outside perturbation (impact, temperature rise, etc.) or by a fault of the electronic system managing the charge status or other parameters of the generators of the battery.

For example, when a lithium electrochemical generator is subjected to an overload, the temperature thereof increases. The increase in temperature leads to an increase in the load current which further promotes the increase in temperature. If the generator does not have a sufficient cooling system to evacuate the emitted heat, the generator suffers thermal runaway: the temperature increase is fed by the generator itself. The uncontrolled temperature increase of the generator leads to the generation of gases and expansion thereof inside the container of the generator. This expansion may lead to an increase in the internal pressure inside the generator which opens up the gas evacuation safety system. In the event of release of hot gases whose temperature can reach up to 650° C., these gases come into contact with the other generators of the battery. There is a risk that the phenomenon of thermal runaway will propagate to all the generators of the battery leading to total destruction thereof. This risk is particularly high with generators of lithium-ion type.

Document GB 938359 describes a battery of electrochemical generators comprising a case in which a plurality of electrochemical generators is arranged. The generators are held in position through the use of polyurethane foam which fills the space between the electrochemical generators.

Document CN 101106185 describes a battery of lithium-ion electrochemical generators in which the space between the electrochemical generators is filled with a flame-retardant material. This document does not disclose the form in which this material is used. In particular it does not disclose the use of the material in foam form.

Document JP 04-002043 describes an electrochemical generator housed in a casing. This generator is surrounded by polyurethane foam. The polyurethane foam is used to prevent moisture from entering the generator. In addition, it forms a lightweight filler material.

Document JP 07-296786 describes a casing containing a plurality of electrochemical generators. On this casing there are installed a printed circuit board carrying current terminals, a fuse support and a thermistor support. The casing is covered with polyurethane foam providing the casing with better impact resistance.

Document JP 11-210982 describes an electrochemical generator covered with thermal insulating material. This material comprises a layer of reinforcing material such as a polyvinyl sheet and flame-retardant polyurethane foam. This avoids lowering of the electrical performance of the electrochemical generator when it is exposed to temperatures down to −30° C.

Document JP 62-211854 describes a lithium generator of button format arranged in a casing. Polyurethane is used as filling material between the generator and the casing to prevent moisture from entering the generator and thereby increase the lifetime of the generator.

Document JP 2006-324014 describes a polyurethane-based sealing agent for a generator of parallelepiped type. This sealing agent adheres well to the generator container, has good resistance to the electrolyte and good thermal resistance.

Documents U.S. Pat. No. 3,269,865 and CA 767207 describe a lead-acid generator in which polyurethane foam is used to fill the space remaining between the bottom of the case of the generator and the electrochemical bundle. The polyurethane foam makes the generator vibration-resistant.

Document JP 09-120812 describes a battery of electrochemical generators in which the upper, lower and peripheral parts of the generators are covered with acrylic resin foam. This foam allows the absorbing of outside vibrations and/or imp acts.

Document JP 2006-339017 describes a battery of lithium generators in which the space between the generators is filled with a plastic material having a thermal conductivity of between 0.05 W/mK and 3 W/mK. The plastic material allows the avoiding of thermal runaway propagation from one generator to an adjacent generator. The use of a plastic material in foam form is not described.

Document KR 2004-0105338 describes a lithium generator comprising a reserve of extinguishing agent used to prevent combustion of the generator when the internal pressure thereof exceeds a nominal value.

Document US 2007/0259258 describes a battery of lithium generators in which the generators are stacked one on another and this stack is held in position being surrounded by polyurethane foam. An embodiment is also disclosed in which cooling fins are inserted between two generators.

Document DE 202005010708 describes a starter lead-acid electrochemical generator and an electrochemical generator for industrial use whose housing contains plastic foam such as polypropylene or polyvinyl chloride having closed pores.

Document JP 2002-231297 describes a battery of lithium generators connected in parallel. The positive electrodes of each of the generators are together connected to a positive current collector. Similarly, the negative electrodes of each of the generators are together connected to a negative current collector. Plastic foam is arranged in the bottom of the battery housing and on the inner wall of the lid. This arrangement of the foam allows the avoiding of electrode breakage.

Document EP-A-0 676 818 describes a protective container for electrochemical generator against variations in temperature. This container has a second casing in insulating material made from polyurethane foam. This second casing surrounds the electrochemical generator.

Document U.S. Pat. No. 5,352,454 describes a lead-acid generator in which that part of the electrodes not covered with active material and the current collectors are embedded in a polyurethane foam with open pores. This foam fills the space existing between the upper part of the electrochemical bundle and the lid of the generator. The foam pores form an assembly of tiny volumes communicating with each other and capable of containing the gases e.g. hydrogen emitted in the event of overload of the electrochemical generator. In this manner, the volume of gases likely to ignite and cause explosion of the generator is reduced.

Document U.S. Pat. No. 4,418,127 describes a battery of high-power lithium electrochemical generators. Flame-retardant polyurethane foam is arranged between the inner wall of the battery container and the generators. The flame-retardant polyurethane foam surrounds the generator container, including the side of the generator carrying the current output terminals.

Document CA 1064575 describes a method for joining the two sheets of a separator of envelope type for an electrochemical generator. A foam of polymer resin such as a polyolefin is applied to the edge of the two sheets held against each other in a vise.

It is sought to find means for combating propagation of the phenomenon of thermal runaway from one generator to the other generators in a battery, particularly with regard to generators of lithium-ion type.

### SUMMARY OF THE INVENTION

The subject of the invention is a battery 1 of lithium electrochemical generators comprising:
a casing 2;
a plurality of lithium electrochemical generators 3, 3′, 3″ housed in the casing, each generator comprising a container 4;
a rigid, flame-retardant foam 10 with closed porosity formed of an electrically insulating material filling the space between the inner wall of the casing 11 and the free surface of the side wall 12 of the container of each electrochemical generator, said foam covering the free surface of the side wall of each electrochemical generator over a length representing at least 25% of the height of the container.

According to one embodiment, the free surface of the side wall of the container of each electrochemical generator represents the entirety of the surface of the side wall of the container.

According to one embodiment, the free surface of the side wall of the container of each electrochemical generator represents from 25% to 75%, preferably 40% to 60%, more preferably 45% to 55% of the surface of the side wall of the container.

According to one embodiment, the casing comprises an inner wall following the contour of the side wall of at least one container, the inner wall of the casing being in contact with said side wall of said container.

According to one embodiment, the foams covers the free surface of the side wall 12 of the container of each generator over a length representing at least 50% of the height of the container, more preferably at least 75% of the height of the container and further preferably the entire height of the container.

According to one embodiment, the container is of cylindrical shape and the foam covers the free surface of the side wall of the container solely over a part lying between the mid-height of the container and the end of the container resting on the casing.

According to one embodiment, the container is of cylindrical shape and the foam covers the free surface of the side wall of the container solely over a part lying between the mid-height of the container and the end of the container not resting on the casing.

According to one embodiment, at least one electrochemical generator comprises a container having one end closed by a wall having a thinning adapted so that it ruptures in the event of overpressure inside the container.

According to one embodiment, the container is of cylindrical shape and the thinning is of circular shape.

According to one embodiment the foam covers the closed end on a surface located outside the circular shape.

According to one embodiment, the electrochemical generators have a capacity of more than 5 Ah.

According to one embodiment, at least one generator is of lithium-ion type.

According to one embodiment, the electric insulating material is a plastic material.

According to one embodiment, the foam consists of a material chosen from the group comprising polyurethane, epoxy, polyethylene, melamine, polyester, formophenol, polystyrene, silicone or a mixture thereof.

According to one embodiment, the thermal conductivity of the foam varies between 0.02 and 1 W/mK, preferably between 0.02 and 0.2 W/mK.

According to one embodiment, the foam comprises a flame-retardant compound chosen from the group comprising trichloropropyl phosphate (TCPP), triethyl phosphate (TEP), diethyl ethyl phosphate (DEEP), a brominated polyether polyol, brominated phthalic anhydride, ammonium polyphosphate, encapsulated red phosphorus, or a mixture thereof.

According to one embodiment, the foam comprises fillers chosen from the group comprising trihydrated aluminium, calcium carbonate, barium sulphate, glass fibres, carbon fibres, melamine, carbon black, silicon oxide, or a mixture thereof.

According to one embodiment, the density of the foam varies between 5 and 800 kg/m³.

According to one embodiment, the following are arranged in the casing 2 of the battery:
at least one flange 16 comprising a plurality of cut-outs 76 able to interlock with a portion of the container of each of the generators and/or with a lid 6 closing the container of each of the generators,
at least one elastomer seal 15 arranged on said flange, said seal comprising a plurality of openings 75 coinciding with the cut-outs of the flange.

Preferably, a first flange interlocks with a portion of the container of each of the generators, and a second flange interlocks with the lid of each of the generators.

The invention is more particularly intended to be applied to batteries of storage lithium electrochemical generators of which some of the components are flammable. An improvement in the safety of users is essential in the sectors of electric vehicles, telecommunications and renewable energies.

### BRIEF DESCRIPTION OF THE FIGURES

FIG. 1 schematically illustrates a longitudinal section of a battery 1 according to the invention in which the space between the inner wall of the casing 11 and the side wall 12 of the container of each electrochemical generator is filled with rigid, flame-retardant plastic foam 10.

FIG. 2 schematically illustrates a view of the upper side of the battery shown FIG. 1.

FIG. 3 schematically illustrates the embodiment in which the foam 10 covers the side wall 12 of the container solely on the lower part of the container.

FIG. 4 schematically illustrates the embodiment in which the foam 10 covers the side wall 12 of the container solely on the upper part of the container.

FIG. 5 shows an electrochemical generator 3 whose container 4 in its lower part has a bottom comprising a thinning 13, 13′, 13″ acting as safety device in the event of overpressure inside the container. The foam 10 covers part of the bottom over a surface located outside the circular shape.

FIG. 6 is an overhead view of a battery according to one embodiment of the invention.

FIG. 7 is an exploded view of the pack according to one embodiment of the invention. Element 71 is a flame arrester element e.g. a board, element 72 is an electrically insulating plate, element 73 is a spacer, element 74 is an electric distribution system (“busbar”), element 15 is an elastomer seal comprising a plurality of openings 75 and element 16 is a flange comprising a plurality of cut-outs 76.

FIG. 8 is an overhead view of an elastomer seal 15 attached, for example using an adhesive, to a flange 16.

FIG. 9 schematizes the positioning of the different elements of the pack 91 in the casing 2, before injection of the foam.

FIG. 10 is a cross-sectional photograph along the length of the generators, of a battery portion on which the sealing areas inside the battery are shown. Area 101 is the seal between the casing and the pack. Area 102 is the circular (or ring-shaped) seal between the flange and the container of the electrochemical generator.

### DETAILED DISCLOSURE OF EMBODIMENTS

The invention lies in the finding that it is possible to combat the propagation of fire to the other generators of the battery by covering the side wall of the container of each generator with a flame-retardant foam having closed porosity formed of an electrically insulating material. The foam used in the invention is rigid and flame-retardant: it maintains its closed porosity and rigid, sealed structure even in the event of a strong increase in temperature due to fire and/or hot gases. When a gas is vented via the opening of the container of one of the generators, subsequent to abnormal functioning of the battery, the plastic foam firstly acts as thermal insulator preventing the heat emitted by the faulty generator from propagating to adjacent generators. In addition, the closed porosity of the foam forces the hot gases emitted by the faulty generator to evacuate outside the battery via a full or partial opening in the casing underneath the generators. The closed porosity of the foam forms a sealed porous structure preventing hot gases or flames from circulating between the electrochemical generators. This “barrier” effect against hot gases is unexpected with foam whereas it follows from the solid structure of a resin material such as used in document JP 2006-339017. The choice and use of foam with closed porosity allow the obtaining of this barrier effect. The foam opposes the propagation of thermal runaway to the other generators of the battery. The forming of foam in an electrically insulating material e.g. plastic allows a material to be obtained having low thermal conductivity which is not possible with a solid plastic material. In addition, foam generally has a density of less than 800 kg/m³, which allows a lightweight insulating material to be obtained. According to the invention, the rigid, flame-retardant foam with closed porosity formed of an electrically insulating material covers the free surface of the side wall of the container of each electrochemical generator. By free surface is meant the surface of the side wall which is not in contact with a wall of the casing. According to the invention, the foam covers the free surface of the side wall of the container of each electrochemical generator over a length representing at least 25% of the height of the container.

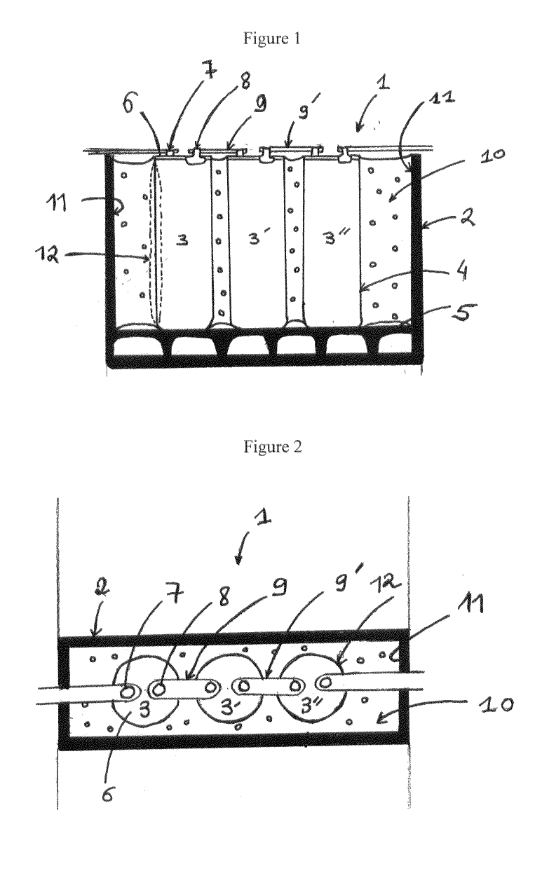

A battery according to one embodiment of the invention will now be described with reference to FIGS. 1 and 2. FIG. 1 illustrates a battery 1 comprising a casing 2 intended to receive at least two electrochemical generators 3, 3′, 3″. The casing may comprise a lid (not illustrated).

Each generator comprises a container 4 containing:

a) an electrochemical bundle i.e. the assembly consisting of alternate positive and negative electrodes separated by a separator;
b) a liquid electrolyte.

The container 4 is preferably of cylindrical shape, but other forms can be envisaged such as a parallelepiped format (prismatic). The container has a wall at one of its ends resting on the bottom of the casing 5. The container is closed at the opposite end by a lid 6 carrying the current output terminals 7, 8. One of the two terminals 7 can be secured to the outer wall of the lid and electrically connected to the cylindrical wall of the container. The other terminal 8 can be secured through the lid and electrically insulated from the lid by a seal in plastic material. FIG. 2 shows that the generator 3′ is connected to the adjacent generators 3 and 3″ via metal strips 9, 9′ which connect each current output terminal of the generator with the current output terminal of opposite polarity of the adjacent generator.

According to the invention, the container of each generator comprises a side wall 12 whose free surface i.e. having no contact with the inner wall of the casing, is covered with rigid, flame-retardant plastic foam 10 with closed porosity. The foam covers the wall over a length representing at least 25% of the height of the container. In one preferred embodiment, the foam covers the free surface of the side wall of the container over a length representing at least 50% of the height of the container, more preferably at least 75% of the height of the container, further preferably at least 90% of the surface of the container. In a more preferred embodiment illustrated FIG. 1 the plastic foam covers the side wall of the container of each electrochemical generator over the entire height of the container. In this case, any short-circuiting through contact between two generators is avoided. This embodiment offers excellent thermal insulation and an improved barrier effect against the propagation of hot gases towards the adjacent generator(s). The flame-retardant plastic foam also fills the space between the inner wall of the casing 11 and the side wall 12 of the container 4 of each electrochemical generator.

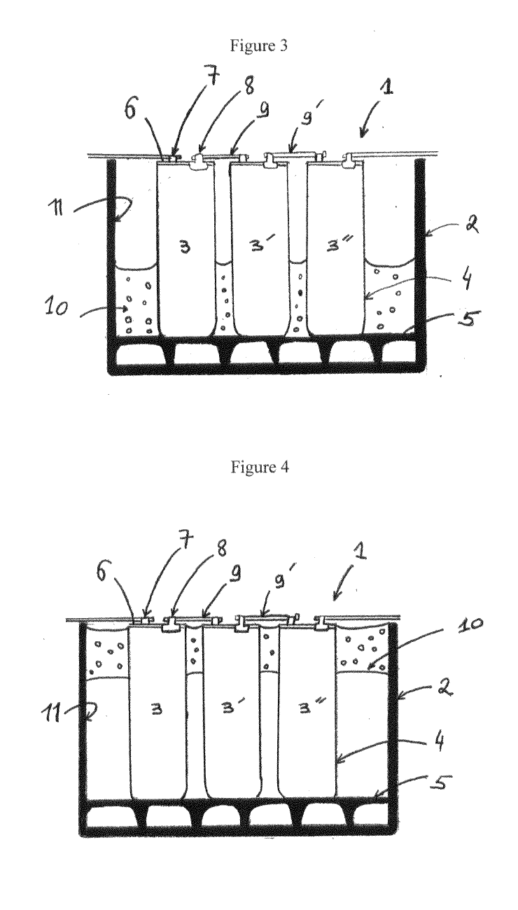

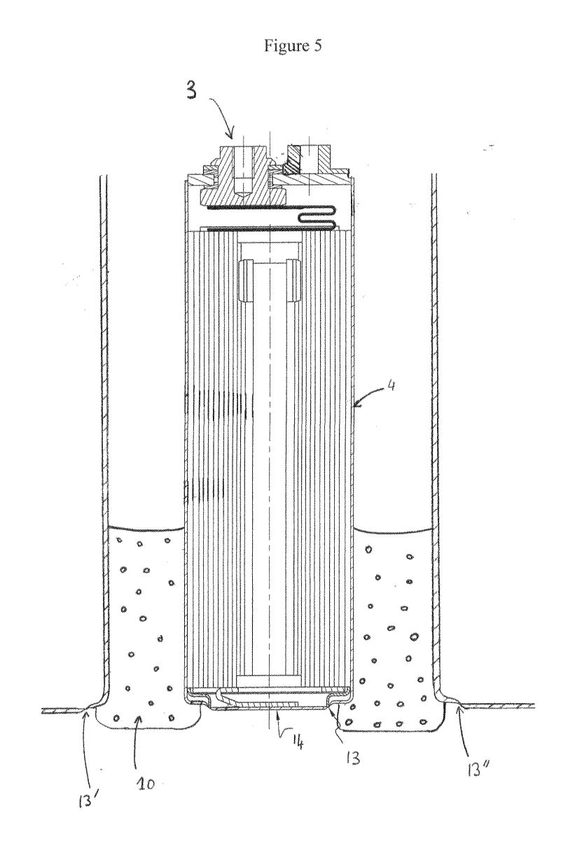

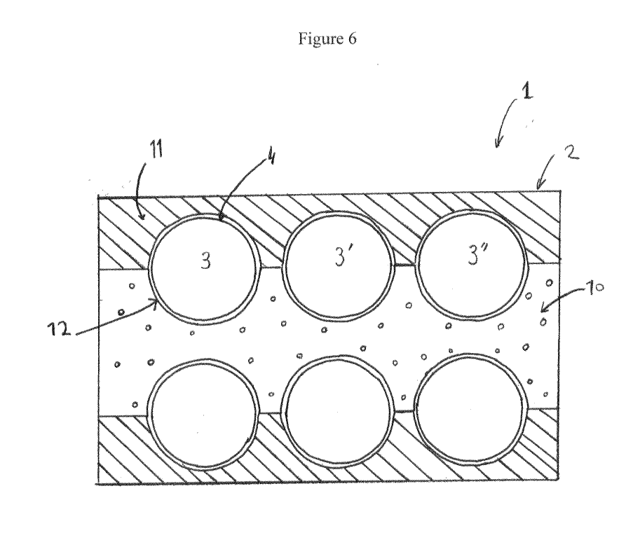

According to one preferred embodiment illustrated FIG. 3, the foam 10 covers the side wall 12 of the container 4 solely on its lower part i.e. the part of the container lying between the mid-height of the container and the end of the container resting on the bottom 5 of the casing. This arrangement of the foam allows propagation of gases to be avoided when they escape via the bottom of the container. It is effectively preferred that the gases escape via the bottom of the container. To force the evacuation of gases via the bottom of the container, it is possible at the time of manufacture of the generator to thin part of the wall of the bottom of the container. A generator comprising said thinning is illustrated FIG. 5. This thinning 13, 13′, 13″ forms a weakened area of the wall of the bottom of the container 14 which ruptures in the event of overpressure inside the container 4 causing the release of gases present in the container. This thinning forms a safety device preventing the inner pressure of the container from exceeding a predetermined threshold value. Said generator is also described in patent FR-B-2 873 495.

The container may be of cylindrical shape in which case the thinning is preferably circular shaped with a diameter smaller than the diameter of the container. The foam may cover the part of the bottom of the container located outside the circle formed by the thinning. Care must be taken however to ensure that the thinning is not masked by the foam, which could prevent the thinning from rupturing in the event of overpressure inside the generator.

It can also be envisaged as illustrated FIG. 4 to arrange the foam 10 at the upper part of the container 4 i.e. the part lying between the mid-height of the container and the end of the container which is not in contact with the casing. This is generally the end 6 carrying the current output terminals 7, 8. It can also be envisaged to arrange the foam both on the upper part and on the lower part of the container. It is also possible to cover the side wall of the container with foam without this foam reaching the upper and lower parts of the container.

In another embodiment of the invention illustrated FIG. 6, a portion of the side wall 12 of the containers is covered with rigid flame-retardant foam 10 with closed porosity formed of an electrically insulating material, whilst the portion non-covered with foam is in contact with the inner wall of the casing 11. The free surface of the container of each of the generators in this example represents around 50% of the total surface of the side wall of the container. The inner wall of the casing follows the contour of the containers. The casing is preferably in plastic material. It can be manufactured by moulding, making it possible to modify the shape of the inner wall in relation to the format of the containers. For example, the containers 4 illustrated FIG. 6 are of cylindrical shape and the inner wall of the casing comprises cut-outs in the shape of semi-tubes intended to coincide with the cylindrical side wall of the container of each of the generators. Firstly, the presence of foam between two adjacent generators allows each generator to be insulated from the other. In the event of failure of one of the generators, the gases do not propagate to the adjacent generator. Secondly, since the inner wall of the casing follows the contour of the containers, it is possible to fix the position and immobilise each generator in the casing. In the example shown FIG. 6, the foam covers about 50% of the free surface of the side wall of the container, but other cover percentages are possible such as 25% to 75%, 40% to 60% or 45% to 55% of the total surface of the side wall of the container.

Overload testing of one of the generators showed that when the inter-generator space is filled with foam, the temperature of the generators adjacent the faulty generator does not reach a critical value for propagation of thermal runaway, although the temperature of the faulty generator whose safety system has been opened under the effect of pressure of the gases, reaches approximately 650° C. The lithium-ion generators adjacent the faulty generator did not undergo any damage due to a rise in their temperature. This non-propagation of the phenomenon of thermal runaway was obtained by means of the maintained characteristics of the foam i.e. the maintained closed porosity, rigidity and sealing.

A conventional battery casing contains volumes of air (voids) which vary according to the outside pressure. In aeronautic applications, the pressure variations generate swelling and deflating of the casing. In the invention, by filling the volumes of air with rigid foam not subject to pressure variations, these phenomena of swelling/deflating are cancelled, casing fatigue is limited and event integration is avoided.

To fill the free spaces with foam, it is possible:

a) either to use a foam which, by expansion, comes to fill the free spaces,
b) or to use a machined or previously moulded foam block that is inserted in the casing at the time of assembly.

The use of expandable foam in the battery facilitates the filling thereof compared with a resin which flows solely under gravity, creating bubbles and causing filling problems. The use of expandable foam facilitates filling since the swell pressure pushes the foam into all the cavities and recesses of the geometry to be filled. Also, this method allows any geometry to be filled which is not possible using prefabricated blocks.

As foam material, it is possible to use polyurethane, epoxy, polyethylene, silicones, melamine, polyester, formophenol and polystyrene, or a mixture thereof, polyurethane and the mixture of polyurethane and epoxy being preferred. Preferably, the thermal conductivity of the foam varies between 0.02 and 1 W/mK.

The forming of rigid plastic foam in polyurethane will now be described. A polyurethane is produced by reaction of a diisocyanate on a hydrogen-donor compound. As examples of hydrogen-donor compounds mention may be made of water, alcohols, amines and ureas. Reference can be made to pages 113-122 of the 2002 edition of the work <<The Polyurethanes Book>> published by John Wiley and Sons.

The expansion of polyurethane resin for foam-form requires the use of a foaming agent. Different routes can be followed to obtain the foam:

a) via chemical route i.e. the reaction of water on isocyanate producing CO₂, which will cause the polyurethane to foam;

b) via physical route i.e. vaporisation of a liquid with low boiling point, under the action of heat produced by the exothermal reaction between isocyanate and the hydrogen-donor compound;

c) via injection of air.

The physical route is preferred to prepare rigid foams. Hydrochlorofluorocarbons (HCFCs), hydrofluorocarbons (HFCs) and hydrocarbons (HCs) can be used as foaming agents. They are considered as alternatives to chlorofluorocarbons (CFCs) suspected of contributing towards depletion of the stratospheric ozone layer. In the group of hydrochlorofluorocarbons (HCFCs) mention may be made of the following compounds: CHClF₂ (HCFC-22), CH₃CClF₂ (HCFC-142b), CH₃CCl₂F (HCFC-141b) and CH₃CH₂ClCH₃ (2-chloropropane). In the group of hydrofluorocarbons (HFCs) the following compounds may be cited: CH₂FCF₃ (HFC-134a), CHF₂CH₃ (HFC-152a), CH₃CH₂CHF₂ (HFC-245fa) and CH₃CH₂CF₂CH₃ (HFC-365 mfc). In the hydrocarbon group (HCs) the following compounds can be mentioned: iso-butane C₄H₁₀, iso-pentane C₅H₁₂, n-pentane CH₃CH₂CHF₂ and cyclo-pentane (CH₂)₅. The use of hydrocarbons requires special precautions on account of their high flammability. Reference can be made to pages 131-134 of the 2002 edition of the work <<The Polyurethanes Book>> published by John Wiley and Sons.

Rigid polyurethane foam can be prepared by mixing methylene diphenyl diisocyanate (MDI) or toluene diisocyanate (TDI) with a polyol, a foaming agent from among those cited above, a flame-retardant agent, optionally a catalyst and water. A cross-linking agent such as triethanolamine or glycerine can be used to improve the rigidity of the foam.

Most rigid polyurethane foams are characterized by alveoli of closed type (closed porosity). The percentage of closed alveoli is generally between 90 and 95%. It is possible to obtain alveoli of closed type when the wall of the alveoli remains intact during the foam forming step. The wall is not destroyed by the pressure of expanding gases in the alveolus. The increase in temperature of the reaction mixture plays a determinant role in the increase in internal pressure inside the alveolus. Expansion of the resin by physical route such as described in the foregoing allows the reaction mixture to be cooled by evaporation of the liquid with low boiling point. The increase in pressure therefore occurs at the time when the wall of the alveoli has become rigid. The use of the chemical route leads to a higher temperature of the reaction mixture. A rapid increase in temperature and pressure may possibly lead to destruction of the wall of the alveoli. The formation of the rigid polyurethane foam is described in more detail on pages 248-251 of the second edition of the work <<Polyurethane Handbook>> published by Hanser Gardner.

The flame-retardant agent incorporated in the foam is intended to reduce quantities of flames and combustion products. It has high latent heat of transformation. It can be chosen from the group comprising trichloropropyl phosphate (TCPP), triethyl phosphate (TEP), diethyl ethyl phosphate (DEEP), diethyl bis(2-hydroxyethyl) amino methyl phosphonate, brominated phthalic anhydride, dibromoneopentyl glycol, brominated polyether polyols, melamine, trihydrated aluminium, ammonium polyphosphate and encapsulated red phosphorus. One preferred flame-retardant agent is trichloropropyl phosphate (TCPP) since it contains a high amount of phosphorus and chlorine. It is in the form of a slightly viscous liquid. It is therefore easy to use. Brominated polyether polyol and brominated phthalic anhydride contain a large quantity of bromine. Triethyl phosphate (TEP) and diethyl ethyl phosphate (DEEP) are preferred when the use of halogens is prohibited. The flame-retardant agent generally represents 3 to 10 percent of the plastic foam.

The rigid flame-retardant foam may also contain fillers such as trihydrated aluminium, calcium carbonate, barium sulphate, glass fibres, carbon fibres, melamine, carbon black, silicon oxide.

Reference can be made to pages 160-162 of the 2002 edition of the work titled <<The Polyurethanes Book>> published by John Wiley and Sons, Ltd. and to pages 111-113 of the second edition of the work titled <<Polyurethane Handbook>> published by Hanser Gardner Publications for more details on flame-retardant agents and fillers.

The invention can also be implemented using an epoxy foam produced from an epoxy resin. The epoxy resin can be obtained by mixing epichlorohydrine with bisphenol A. The foaming agent may be air or a compound with low boiling point e.g. pentane. The foaming agent is added in a quantity of between 5 and 30% by weight of the epoxy resin. It is also possible to use compounds such as sodium bicarbonate and calcium carbonate which release carbon dioxide in the presence of an acid.

The invention can also be implemented using a polystyrene foam. As foaming agent, use may be made of butane, pentane, hexane and heptane. It is also possible to use air, carbon dioxide, nitrogen, methane, helium, argon and neon as agent. Polystyrene is dissolved by some aromatic hydrocarbons such as benzene, toluene, xylene and ethylbenzene, and by some chlorinated aliphatic hydrocarbons such as methylene chloride, chloroform and carbon tetrachloride. These compounds cannot therefore be used as foaming agents.

According to one embodiment of the invention, at least on elastomer seal 15 is arranged in the casing and held in position for example by means of an adhesive against the surface of a flange 16 which is in contact with the bottom of the container of the generators or with the lid of the generators.

The flange acts as jig which helps to hold in place the plurality of electrochemical generators through the presence of cut-outs 76. These cut-outs interlock with (or are adapted to receive) a portion of the surface of the container such as the bottom of the container or a lid used to close the container. The cut-outs are made to follow the contour either of the shape of the lid of the container or the shape of the bottom of the container.

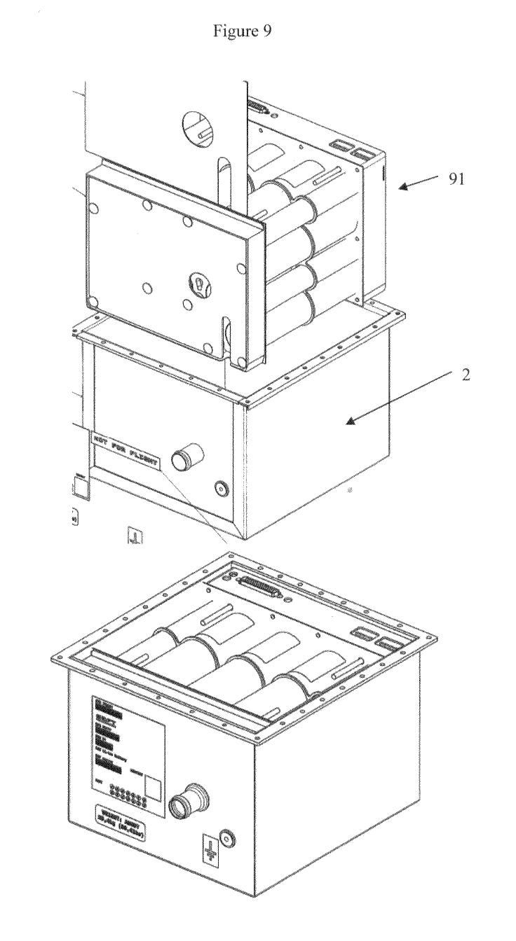

The elastomer seal has a plurality of openings 75 whose edge coincides with the limit of a cut-out (FIG. 8). Preferably, the surface of the opening is smaller than the surface defined by the limit of the cut-out to provide a good seal between the container and the elastomer seal. The elastomer seal, through its high deforming capability, allows the offsetting of any play inside a mechanical assembly. The assembly comprising the different elements forms a closed volume into which the foam is injected.

The spacer 73 is an element used to fill the empty space between the electrochemical generators. It provides reinforced rigidity to the battery.

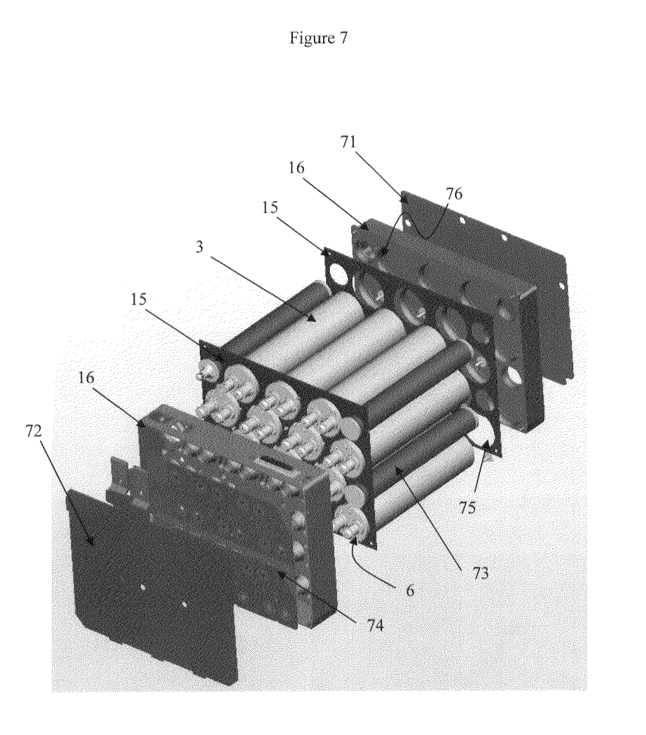

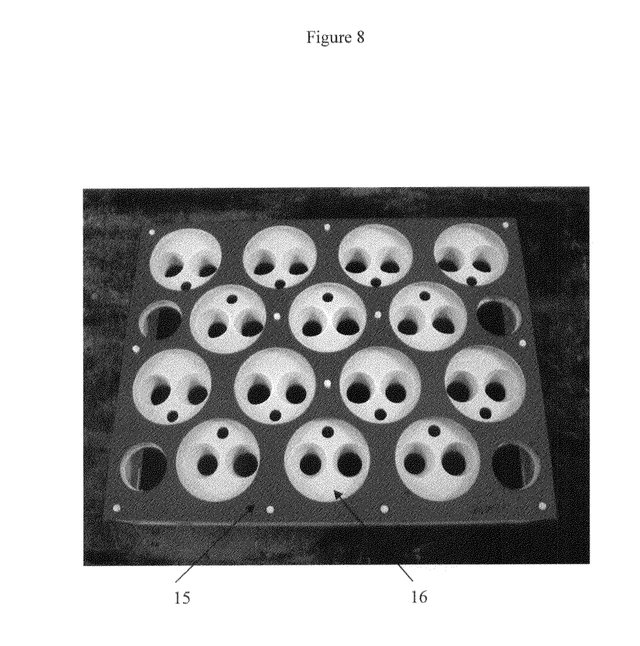

A pack (FIG. 7) comprises the assembly of:
the plurality of electrochemical generators,
elements for holding in place the plurality of electrochemical generators in the casing (flanges, elastomer seals, spacers),
electric and thermal insulating elements (flame arrester, insulating plate),
electric connection elements (power connects and connections for management of the battery's operating parameters).

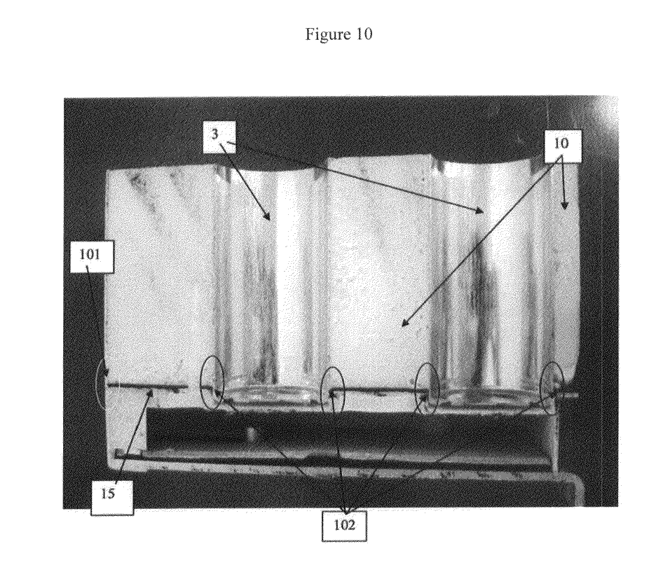

The contacted insertion of the electrochemical generators in the flanges through elastomer seals provides annular contact over the entire surface of the electrochemical generators. Therefore, any play existing between a generator and the flange is limited as illustrated by the sealing areas 102 in FIG. 10. A sealed assembly is obtained through the positioning of an elastomer seal and of a flange at the end of each electrochemical generator.

In addition, the elastomer seal fixed on a flange generates a lip which spills over the flange and comes into contact with the casing, guaranteeing the absence of any play—as illustrated by the sealing area 101 in FIG. 10—between the pack and the casing, such play being likely to cause foam leakage (the dimensions—length and width—of the seal exceed the dimensions of the flange by a few millimetres).

This embodiment inter alia allows the sealed assembly of electrochemical generators having a cylindrical or parallelepiped format. FIG. 9 is a diagram showing the positioning of the pack 91 in the casing 2.

The combined use of a flange and an elastomer seal reduces the risks of foam leakage. Indeed, currently known methods for injecting foam cause foam leakage at the time of foam injection and assembly of the battery of generators. Variability related to the quantity of injected foam and the temperature at which it is injected have an influence of the extent of leakage. Therefore leaks of greater or lesser extent are observed. These leaks place stresses on the power connections, which deteriorates contact resistances between the electrochemical elements and power connects and even degrades the electronic components of the boards arranged in the interconnect volume. These leaks also cause obstruction of the safety devices used to control an increase in pressure inside the electrochemical generator. For example, these devices may consist of a valve, of a thinning or of a weakened area of the wall of the container of the electrochemical generator. Battery performances are deteriorated as a result of these leak phenomena. In addition, these foam leaks reduce the quantity of foam which should be contained within the dedicated volume. Therefore, once the foam has expanded, it is of reduced volume compared with the expected volume, requiring the re-injection of foam after assembly of the battery.

The generators used are of lithium type, preferably lithium-ion type. Generators of lithium polymer type or lithium generators with a liquid cathode such as Li/SO₂, Li/SOCl₂, Li/MnO₂Li/CFₓ, Li/MnO₂+CFₓ or LiSO₂Cl₂ can also be used.

In addition to its ability to limit the risk of propagation of thermal runaway in high power lithium-ion generators, the battery of the invention has the following advantages:
it provides excellent mechanical support to the generators even at high temperature, on account of the rigidity of the foam; the filler foam adheres very strongly to all the battery constituents thereby rigidifying the battery. Any relative movement of the generators is therefore limited. This advantage is determinant for qualifying the battery as per standards relating to vibration and impact.
it allows the avoiding of contact between the containers of two adjacent generators in the event of deformation of the container of one of the generators. Risks of short-circuiting are therefore reduced. For example, in the field of telecommunications, a battery of 80 Ah has good impact resistance. Generators were wedged with polyurethane foam to form a battery of 30 Kg. The battery was dropped from a height of 5 m. The generators protected by the foam remained intact and any contact between generators was avoided.
it has better resistance to variations in pressure outside the battery. The battery of the invention limits fatigue of the casing due to swelling-deflation cycles during high-altitude flights. The filling of the space in the battery with foam overcomes this constraint.
it allows an increase in resonance frequency and therefore limitation of extensive shifts in low frequency ranges. For example the functioning of a 50 Ah battery in the field of aeronautics is little perturbed by vibration frequencies in the 0 to 100 Hz range. Research on resonance frequency showed that a foam-free battery has a relatively low resonance frequency (70 Hz), whereas a foam-filled battery has a much higher frequency (120 Hz). This increase in resonance frequency places the battery in a much higher frequency range and therefore avoids a good number of vibration spectra in which the [0 Hz-100 Hz] portion comprises high accelerations and strong shifts.
it provides sufficient sealing to guarantee the maintained positioning of the foam within its dedicated volume. It is not necessary to add any additional foam at the assembly step. There is therefore no leakage, guaranteeing the maintained performances of the battery and the safety of battery operation.

1. Battery of lithium electrochemical generators comprising:
a casing;
a plurality of lithium electrochemical generators housed in the casing, each generator comprising a container;
a rigid, flame-retardant foam with closed porosity formed of an electrically insulating material filling the space between the inner wall of the casing and the free surface of the side wall of the container of each electrochemical generator, said foam covering the free surface of the side wall of the container of each electrochemical generator over a length representing at least 25% of the height of the container.

2. The battery according to claim 1, wherein the free surface of the side wall of the container of each electrochemical generator represents the entirety of the surface of the side wall of the container.

3. The battery according to claim 1, wherein the free surface of the side wall of the container of each electrochemical generator represents from 25% to 75%, preferably 40% to 60%, more preferably 45% to 55% of the surface of the side wall of the container.

4. The battery according to claim 1, wherein the casing comprises an inner wall following the contour of the side wall of at least one container, the inner wall of the casing being in contact with said side wall of said container.

5. The battery according to claim 1, wherein the foam covers the free surface of the side wall of the container of each generator over a length representing at least 50% of the height of the container, more preferably at least 75% of the height of the container and further preferably the entire height of the container.

6. The battery according to claim 1, wherein the container is of cylindrical shape and the foam covers the free surface of the side wall of the container solely on a part lying between the mid-height of the container and the end of the container resting on the casing.

7. The battery according to claim 1, wherein the container is of cylindrical shape and the foam covers the free surface of the side wall of the container solely on a part lying between the mid-height of the container and the end of the container not resting on the casing.

8. The battery according to claim 1, wherein at least one electrochemical generator comprises a container having one end closed by a wall having a thinning adapted so that it ruptures under an overpressure inside the container.

9. The battery according to claim 8, wherein the container is of cylindrical shape and the thinning is of circular shape.

10. The battery according to claim 9, wherein the foam covers the closed end over a surface located outside the circular shape.

11. The battery according to claim 1, wherein the electrochemical generators have a capacity of more than 5 Ah.

12. The battery according to claim 1, wherein at least one generator is of lithium-ion type.

13. The battery according to claim 1, wherein the electric insulating material is a plastic material.

14. The battery according to claim 1, wherein the foam is formed of a material chosen from the group comprising polyurethane, epoxy, polyethylene, melamine, polyester, formophenol, polystyrene, silicone or a mixture thereof.

15. The battery according to claim 1, wherein the thermal conductivity of the foam varies between 0.02 and 1 W/mK, preferably between 0.02 and 0.2 W/mK.

16. The battery according to claim 1, wherein the foam comprises a flame-retardant compound chosen from the group comprising trichloropropyl phosphate (TCPP), triethyl phosphate (TEP), diethyl ethyl phosphate (DEEP), a brominated polyether polyol, brominated phthalic anhydride, ammonium polyphosphate, encapsulated red phosphorus, or a mixture thereof.

17. The battery according to claim 1, wherein the foam comprises fillers chosen from the group comprising trihydrated aluminium, calcium carbonate, barium sulphate, glass fibres, carbon fibres, melamine, carbon black, silicon oxide, or a mixture thereof.

18. The battery according to claim 1, wherein the density of the foam varies between 5 and 800 kg/m3.

19. The battery according to claim 1, wherein the following are arranged in the casing:
at least one flange comprising a plurality of cut-outs capable of interlocking with a portion of the container of each of the generators and/or with a lid closing the container of each of the generators,
at least one elastomer seal arranged on said flange, said seal comprises a plurality of openings coinciding with the cut-outs of the flange.

20. The battery according to claim 19, wherein a first flange interlocks with a portion of the container of each of the generators and a second flange interlocks with the lid of each of the generators.
